(19) United States
(12) Patent Application Publication
(10) Pub. No.: US 2006/0285831 A1
(43) Pub. Date: Dec. 21, 2006

(54) Imaging apparatus for controlling imaging timing based on frame rate stored in advance

(75) Inventor: Satoshi Tanaka, Tokorozawa-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/384,916

(22) Filed: Mar. 20, 2006

(30) Foreign Application Priority Data
Jun. 16, 2005 (JP) 2005-176148

(51) Int. Cl. H04N 7/26

(52) U.S. Cl. 386/112

(57) ABSTRACT

An imaging apparatus for performing imaging with a variable frame rate includes an imaging section for performing photoelectric conversion of an image of a subject, and outputting converted data as image data; a frame rate data input section into which frame rate data indicating a variation in the frame rate over time is input; a frame rate data storage section for storing the frame rate data input to the frame rate data input section; and a timing control section for controlling timing of imaging performed by the imaging section, based on the frame rate data stored in the frame rate data storage section. The apparatus may include a storage device for storing the image data output from the imaging section; and a control section for controlling, in image reproduction, output of the image data from the storage device by using the frame rate data used in the imaging.

Priority is claimed on Japanese Patent Application No. 2005-176148, filed Jun. 16, 2005, the content of which is incorporated herein by reference.

### BACKGROUND OF THE INVENTION

1. Field of the Invention

The present invention relates to an imaging apparatus for performing imaging and obtaining images with variable frame rates.

2. Description of the Related Art

In recent years, electronic photographing systems for photographing with variable frame rates have been popular, with which special effects such as a slow motion effect or a quick motion effect can be added to images taken. Reference Document 1 (Japanese Unexamined Patent Application, First Publication No. 2005-39708) discloses using an imaging apparatus employing variable frame rates so as to easily obtain special video effects such as high-speed or slow playback for imaging using a video camera, for the purposes of digitized production of television programs or movies. This imaging apparatus is capable of performing imaging using a frame rate lower than a specific frame rate assigned for playback, and reproducing obtained images at the specific frame rate for playback, thereby easily obtaining high-speed reproduced images (i.e., fast playback). The imaging apparatus is also capable of performing imaging using a frame rate higher than the specific frame rate and reproducing obtained images at the specific frame rate for playback, thereby easily obtaining low-speed reproduced images (i.e., slow playback).

### SUMMARY OF THE INVENTION

The present invention provides an imaging apparatus for performing imaging with a variable frame rate, comprising:

an imaging section for performing photoelectric conversion of an image of a subject, and outputting converted data as image data;

a frame rate data input section into which frame rate data indicating a variation in the frame rate over time is input;

a frame rate data storage section for storing the frame rate data input to the frame rate data input section; and

a timing control section for controlling timing of imaging performed by the imaging section, based on the frame rate data stored in the frame rate data storage section.

In a first typical example, the imaging apparatus further comprises:

a storage section having a storage medium on which the image data output from the imaging section is stored; and

a reproduction control section for controlling, in image reproduction, output of the image data from the storage medium by using the frame rate data which is used in the imaging.

In a second typical example, a plurality of items of the frame rate data can be input using the frame rate data input section;

the timing control section controls the timing of imaging performed by the imaging section, based on frame rate data selected from among the plurality of items of the frame rate data stored in the frame rate data storage section; and

the imaging apparatus further comprises:

a storage section having a storage medium on which the image data output from the imaging section is stored; and

a reproduction control section for reading out frame rate data from the frame rate data storage section which is different from the frame rate data used in the imaging of the subject, and controlling, in image reproduction, output of the image data from the storage medium based on the read out frame rate data.

The imaging apparatus may further comprise:

a video encoding section for encoding the image data output from the storage medium; and

a display section for displaying images based on the image data encoded by the video encoding section,

wherein in image reproduction, the reproduction control section controls output of the image data from the storage medium based on a display frame rate of the display section.

When the above structure is applied to the above first typical example, it is possible that:

when the frame rate data input to the frame rate data input section is different from the display frame rate of the display section, the reproduction control section adjusts data of the image data from the storage medium so that desired image reproduction is performed at the display frame rate.

When the above structure employing the display section is applied to the above second typical example, it is possible that:

when the read out frame rate data is different from the display frame rate of the display section, the reproduction control section adjusts data of the image data from the storage medium so that desired image reproduction is performed at the display frame rate.

In another typical example, the frame rate data input section includes:

an operating device, operated by a user, for inputting a value of the frame rate;

a time data generating section for sequentially generating time data indicating an elapsed time measured from a time point; and

a frame rate data generating section for monitoring timing of input of the value of the frame rate via the operating section and the time data generated by the time data generating section, and generating the frame rate data by associating the input value of the frame rate with the time data corresponding to the timing of the input of the value of the frame rate.

The frame rate data input section may include a frame rate data communicating section for communicating with an external device so as to input the frame rate data from the external device.

Preferably, the imaging apparatus further comprises a correction processing section for performing a correction process of correcting the variation in the frame rate indicated by the frame rate data. Typically, the correction process is an interpolation process for smoothing the variation in the frame rate.

### BRIEF DESCRIPTION OF THE DRAWINGS

FIG. 1 is a diagram showing the structure of an imaging apparatus as a first embodiment in accordance with the present invention.

FIG. 2 is also a diagram showing the structure of the imaging apparatus of the first embodiment.

FIG. 3 is a diagram showing the structure of an imaging apparatus as a second embodiment in accordance with the present invention.

FIG. 4 is a diagram showing the structure of an imaging apparatus as a third embodiment in accordance with the present invention.

FIG. 5 is a diagram explaining interpolation performed in the third embodiment.

FIG. 6 is a flowchart showing the operation of the imaging apparatus in the third embodiment.

FIG. 7 is also a flowchart showing the operation of the imaging apparatus in the third embodiment.

### DESCRIPTION OF THE PREFERRED EMBODIMENTS

Hereinafter, preferable embodiments for implementing the present invention will be described with reference to the appended figures.

FIG. 1 is a diagram showing the structure of an imaging apparatus (i.e., a video camera) as a first embodiment in accordance with the present invention. To a frame rate data input section 1, frame rate data is input, which indicates a (temporal) variation in the frame rate over time with respect to the progress of time in imaging.

In a frame rate data storage section 2, the frame rate data input from the frame rate data input section 1 is stored. The frame rate data storage section 2 has a structure for storing one or more items of frame rate data, and includes a storage medium for storing the frame rate data and circuits for writing and reading the frame rate data to and from the storage medium (i.e., for performing storage and readout of the frame rate data). The user can freely select any of the frame rate data stored in the frame rate data storage section 2, and the selected frame rate data is output to a timing control section 3 and a storage control section 8.

In a set imaging time period, the timing control section 3 controls timing of imaging performed by an imaging section 4, based on the frame rate data output from the frame rate data storage section 2. The timing control for imaging, performed by the timing control section 3, includes control of the exposure time (corresponding to an electronic shutter speed) used in the imaging section 4, timing control of horizontal and vertical scanning circuits, timing control of horizontal and vertical synchronizing signals, or the like. Regarding the exposure time, the user can select any desired value, and the exposure time of the imaging section 4 is controlled to have the desired value.

The imaging section 4 has an imaging device such as a CMOS sensor, a CCD sensor, or the like, and performs imaging based on a control signal output from the timing control section 3. The imaging section 4 also performs photoelectric conversion of an image of a subject, and outputs converted data as image data (or an image signal) to an image processing section 5.

The image processing section 5 subjects the image data output from the imaging section 4 to image processing such as white balance correction, gamma correction, outline emphasizing, or the like. The image data processed by the image processing section 5 is output to an image compressing section 6 and a video encoding section 9.

The image compressing section 6 compresses the input image data and outputs compressed image data which is stored as image data in a storage section 7. The storage section 7 includes a storage medium for storing image data, and circuits for writing and reading the image data to and from the storage medium (i.e., performing storage and readout of the image data).

A recording control section 8 controls recording of the image data output from the image compressing section 6. When the image data output from the image compressing section 6 is stored in the storage section 7, the recording control section 8 determines whether the frame rate of the image (data) is a value acceptable to the storage section 7 (i.e., a frame rate value at which the storage section 7 can store the image data), based on the frame rate data. When the frame rate is acceptable, the image data is stored in the storage section 7 without reducing the number of frames. On the other hand, when the frame rate of the image is a high rate at which the entire image data cannot be stored in the storage section 7, some frames in the image data cannot be stored. Therefore, the recording control section 8 performs reduction of the number of frames or the like, so as to store some of the frames belonging to the image data.

The video encoding section 9 encodes the input image data so as to convert the data to a video signal. Based on the video signal output from the video encoding section 9, a display section 10 displays images.

The storage areas in the frame rate data storage section 2 and the storage section 7 can be implemented using nonvolatile memory, a magnetic recording medium, or the like. Both storage areas may be implemented using different storage media, or may be provided as different recording areas on the same storage medium. In addition, the image data compressed by the image compressing section 6 is stored in the storage section 7; however, the present embodiment can also be applied to a case in which the image data is not compressed.

When the storage section 7 stores the image data, data indicating a relationship between the frame rate data used in photographing and the image data is also stored. For example, the storage section 7 associates the image data of each frame with a frame rate value used in photographing, as additional data. As explained later, this frame rate value is read out and used as frame rate data when the image data is reproduced. In another example, the storage section 7 associates the image data with identification data for identifying each item of frame rate data stored in the frame rate data storage section 2, and stores the identification data in association with the image data.

When the recording control section 8 performs reduction of the number of frames as described above, the remaining image data and a corresponding frame rate (or identification data for identifying the frame rate) are associated with each other and are recorded similarly.

As described above, the video camera in the present embodiment has the frame rate data storage section 2. During a predetermined time period of imaging, the timing control section 3 controls timing of imaging by the imaging section 4 based on the frame rate data which is stored in advance by the frame rate data storage section 2. Accordingly, photographing can be performed at a desired frame rate which is temporally varied (i.e., varied over time). Therefore, it is possible to obtain images to which various imaging effects desired by the user (i.e., the photographer) are added.

In addition, the frame rate data storage section 2 stores the frame rate data; thus, any of the stored frame rate data can be selected by the user, and photographing using the same frame rate data can be repeated any number of times. Therefore, images having a reproducible variation in the frame rate can be obtained.

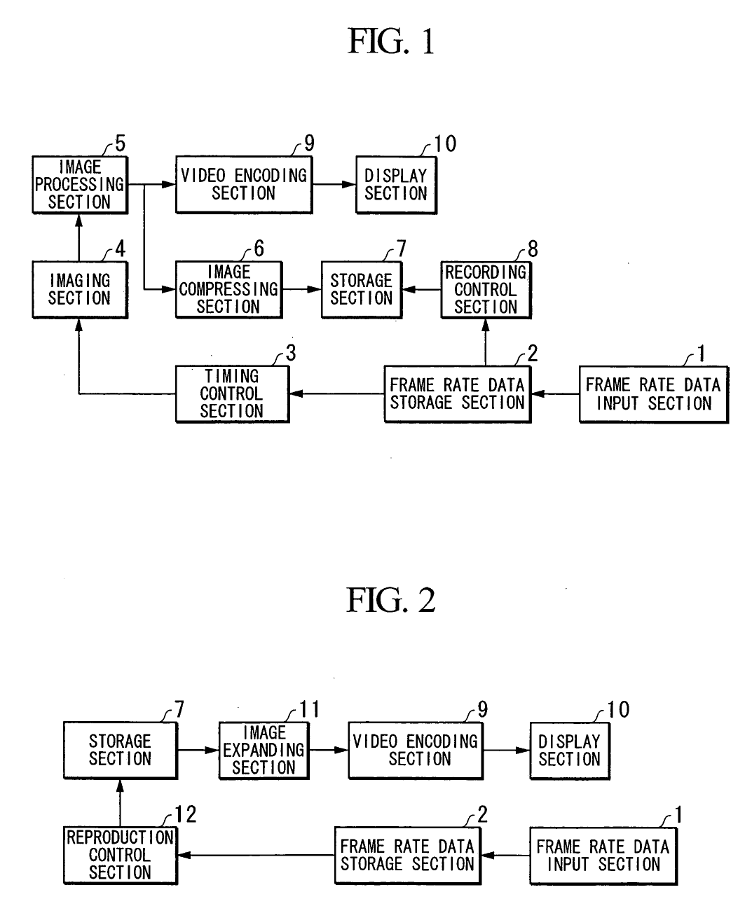

Below, reproduction of the stored images will be explained. FIG. 2 shows a structure necessary for the operation of the video camera in a playback mode. Among structural elements in FIG. 1, those unnecessary for the playback mode are not shown in FIG. 2. In order to reproduce images, the image data stored in the storage section 7 are read out from the storage section 7 and output to an image expanding section 11. In image reproduction, a reproduction control section 12 controls output of the image data from the storage section 7 by using (i) frame rate data which include frame rate values added to the image data read out from the storage section 7, or (ii) frame rate data corresponding to the identification data added to the image data read out from the storage section 7.

When the frame rate of the image data stored in the storage section 7 is different from a frame rate at which the display section 10 can display images (i.e., a display frame rate), stored images in which the motion of an object or the like temporally varies, are reproduced as images having different motion. In order to make the display section 10 display images based on the image data stored in the storage section 7, the image data should be read out at the display frame rate of the display section 10. For example, when the display frame rate of the display section 10 is 30 fps and the image data stored with a frame rate of 30 fps is to be reproduced (that is, when the frame rate of the image data stored in the storage section 7 is the same as the display frame rate), control is performed so that all frames are reproduced at a frame rate of 30 fps, thereby reproducing the image data in real time as in the recording of the image data.

On the other hand, when the image data is stored at a frame rate different from the display frame rate of the display section 10, images can be displayed with different imaging effects depending on reproduction control. For example, when the frame rate of the image stored in the storage section 7 is 60 fps but the display frame rate of the display section 10 is 30 fps, which is a popular frame rate of ordinary display devices, the images cannot be displayed as they are. Therefore, the reproduction control section 12 sets a frame rate for readout of the image data from the storage section 7 to 30 fps, that is, the same value as the display frame rate of the display section 10.

In order to implement this process, the frame rate data input section 1 of the present embodiment has a function of inputting and setting the display frame rate of the display section 10. The display frame rate of the display section 10 input from the frame rate data input section 1 is stored in the frame rate data storage section 2, and the stored data is read out by the reproduction control section 12. In the above-described example of the frame rate, when a display frame rate of 30 fps of the display section 10 is input and set in advance in the frame rate data input section 1, the reproduction control section 12 reproduces the image data at 30 fps in conformity with the display frame rate of the display section 10. In this case, the image data are stored at 60 fps; thus, reproduction of the image data at 30 fps produces half speed slow motion reproduction.

In order to reproduce the image data in real time as in recording of the image data, the above-described input and setting of the display frame rate of the display section 10 is not performed. In this case, the reproduction control section 12 reads out the frame rate data at the recording from the frame rate data storage section 2, and compares the read out frame rate with the display frame rate of the display section 10. Based on the result of comparison, the reproduction control section 12 determines how to reduce the number of frames. For example, the reproduction control section 12 reduces the number of frames at a rate of 2:1 (i.e., a rate between the number of frames at recording and the number of frames used in playback). Accordingly, a part of the recorded frames are deleted; however, the image data are reproduced in real time as in the recording. In addition, when the reproduction is controlled with frame number reduction at the rate of 2:1, images can be reproduced at double the recording speed. In this case, a double-speed fast-forwarding effect can be obtained.

As described above, the video camera of the present embodiment has the reproduction control section 12 which controls the frame rate of data readout from the storage section 7 based on the frame rate data used when obtaining the images. Accordingly, the images can be reproduced with a reproducible variation in the frame rate with respect to the conditions for imaging. Also as described above, the image data stored in the storage section 7 can be reproduced at a frame rate in conformity with the display frame rate of the display section 10, thereby obtaining image output with a newly-added imaging effect.

The frame rate data used in image reproduction may be different from that used in data recording. In this case, the user can designate any frame rate data stored in the frame rate data storage section 2, and the reproduction control section 12 reads out the designated frame rate data from the frame rate data storage section 2 so as to use the read data for reproducing the images. Image output with a newly-added imaging effect can also be obtained by reproducing the images using frame rate data different from that used in recording.

A second embodiment of the present invention will be explained below. In the present embodiment, a method of storing the frame rate data in the frame rate data storage section 2 is described. FIG. 3 shows the structure of an imaging apparatus (i.e., a video camera) in the present embodiment. In FIG. 3, only structural elements relating to frame rate recording are shown, and the other elements which are shown in FIGS. 1 and 2 are not shown.

In the present embodiment, the video camera includes a frame rate control 13 (i.e., an operating device), a time data input section 14 (i.e., a time data generating section), a frame rate data generating section 15, and a frame rate data input and output section 16 (i.e., a frame rate data communicating section). These elements correspond to the frame rate data input section 1 shown in FIGS. 1 and 2.

The frame rate control 13 has a movable member such as a knob, a switch, a lever, or the like, operated by the user, and outputs data in accordance with the operation of the movable member to the frame rate data generating section 15. The frame rate value can be freely changed by operating the movable member, for example, by manually rotating a knob.

The time data input section 14 has a counter for performing counting in synchronism with a real time clock or pulses generated from a real time clock, and sequentially generates time data (which may be counted values or the like) indicating an elapsed time measured from a time point. The time data input section 14 outputs the generated data to the frame rate data generating section 15.

Based on the data output from the frame rate control 13 and the time data input section 14, the frame rate data generating section 15 generates frame rate data and stores the generated frame rate data in the frame rate data storage section 2. In this process, the frame rate data generating section 15 determines the frame rate value designated by the user, based on data (output from the frame rate control 13) in accordance with the operation of the movable member, such as rotation data which indicates a quantity of rotation of a knob.

Based on the data output from the frame rate control 13, the frame rate data generating section 15 monitors timing of input of the frame rate value via the frame rate control 13, and also monitors time data input from the time data input section 14. The frame rate data generating section 15 associates the frame rate value with time data which is input at the same time when the frame rate value is input or at a close time, and stores the associated set of the frame rate value and the time data in the frame rate data storage section 2 as frame rate data. Accordingly, frame rate data having frame rates based on a variation over time as designated by the user can be generated.

Instead of inputting the frame rate data using the frame rate control 13, data indicating a variation in the frame rate over time may be prepared in advance, and the prepared data may be obtained as an electrical signal from an external device, so as to use the data as the frame rate data.

The frame rate data input and output section 16 is used for inputting the frame rate data, which is prepared in advance by an external device such as a personal computer. The frame rate data input and output section 16 has a terminal for input or output of an electrical signal, and communicates with an external device via a cable connected to the terminal, by using an interface such as RS-422. In accordance with the communication, the frame rate data is input from the external device. The input frame rate data is stored in the frame rate data storage section 2. In addition, the frame rate data can also be output from the frame rate data input and output section 16 to an external device.

The generation of the frame rate data using the frame rate data generating section 15 and the input of the frame rate data into the frame rate data input and output section 16 may be performed in advance before photographing, or performed in real time while photographing. When the generation or the input of the frame rate data is performed in real time while photographing, the frame rate data which are sequentially generated or input are stored in the frame rate data storage section 2 and simultaneously output to the timing control section 3, so as to make them usable in timing control for the imaging section 4.

As described above, the video camera of the present embodiment has the frame rate control 13; thus, the user can manually change the frame rate, and images obtained with various variations in the frame rate can be obtained while the user checks the output images. In addition, the video camera of the present embodiment has the frame rate data input and output section 16; thus, frame rate data indicating a desired variation in the frame rate can be input from a personal computer or the like.

Additionally, the frame rate data stored in the frame rate data storage section 2 may be output via the frame rate data input and output section 16 to a personal computer or the like, and the output frame rate data may be edited to have desired edited data as other frame rate data. Furthermore, the edited frame rate data may be again input via the frame rate data input and output section 16 and stored in the frame rate data storage section 2. Accordingly, images having a desired variation in the frame rate can be easily obtained.

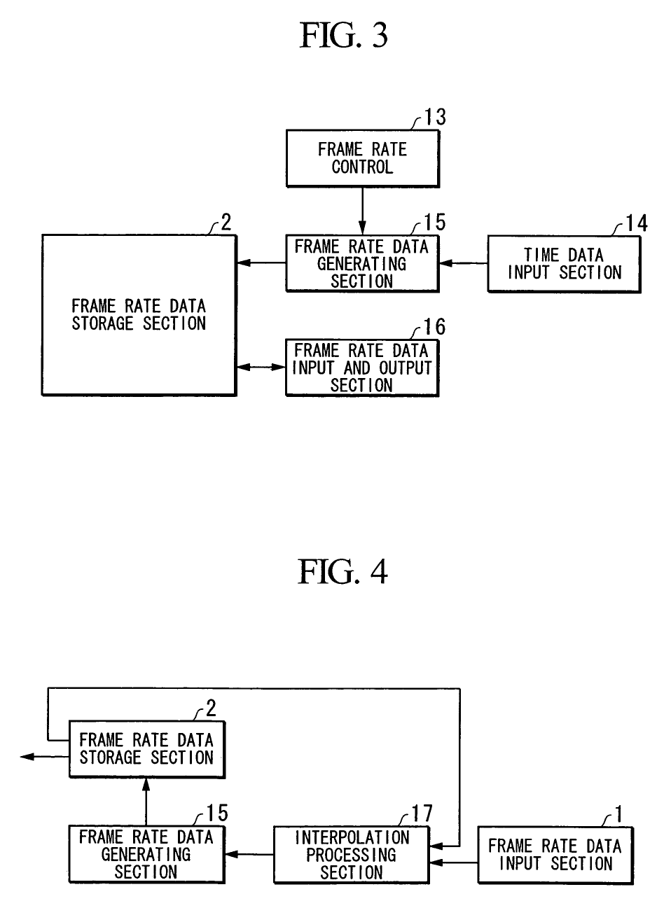

Below, a third embodiment of the present invention will be explained. FIG. 4 shows the structure of an imaging apparatus (i.e., a video camera) in the present embodiment. Also in FIG. 4, structural elements (i.e., not shown in this figure) which are shown in FIGS. 1 to 3 are omitted. In the present embodiment, an interpolation processing section 17 (i.e., a correction processing section) is provided. The frame rate data input section 1 of this embodiment has the frame rate control 13, the time data input section 14, and the frame rate data generating section 15, or the frame rate data input and output section 16, and a series of data (including frame rate data) indicating a variation in the frame rate over time to the interpolation processing section 17. The interpolation processing section 17 subjects the series of data of the frame rate to interpolation (or correction) so that the frame rate varies smoothly.

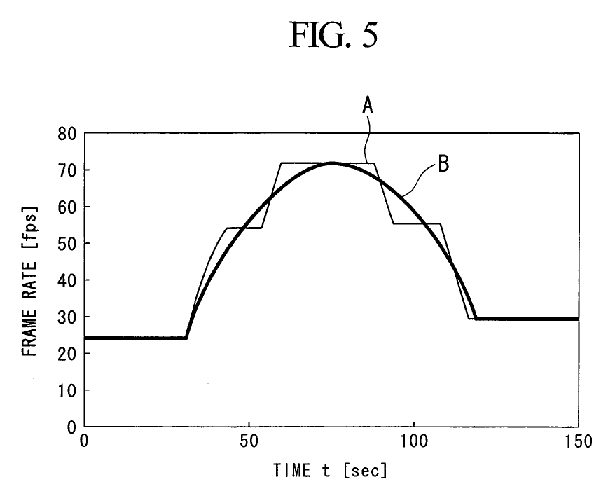

FIG. 5 shows an example of a variation in the frame rate over time. The reference symbol A shows a variation in the frame rate before the interpolation. For example, when the user inputs a frame rate variation by operating the frame rate control 13 or when the step width of the frame rate variation is large, the frame rate variation may not be smooth as shown by the variation A. The interpolation processing section 17 subjects the variation A to interpolation (or correction) by using, for example, second-order polynomial approximation, thereby generating a variation B. When the number of data which form the variation A is insufficient, it is anticipated that the frame rate will not smoothly vary. Therefore, the interpolation processing section 17 computes an approximation of the variation A and interpolates data which form the variation A so as to generate data which form the variation B.

In the interpolation, the order of the polynomial approximation may be three or higher, or another approximation method for producing a smooth and continuous variation, such as a moving average method, may be used. A series of data obtained by the interpolation is output to the frame rate data generating section 15. Based on the received series of data, the frame rate data generating section 15 generates the frame rate data and stores the generated data in the frame rate data storage section 2.

A plurality of items of the frame rate data stored in the frame rate data storage section 2 may be output to the interpolation processing section 17, and a single variation over time may be formed by connecting variations based on each item of the frame rate data. In this process, the interpolation processing section 17 performs interpolation so as to produce a continuous and smooth variation over time.

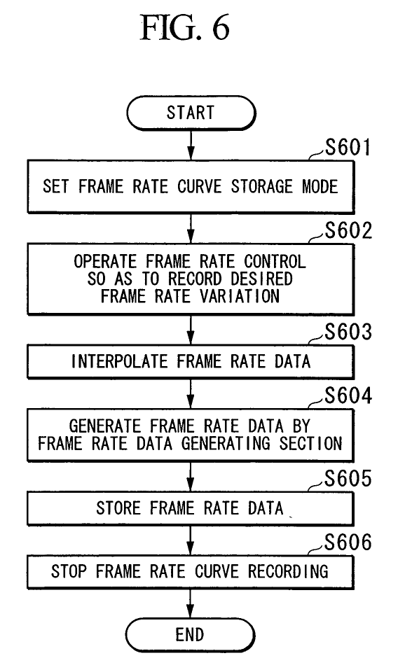

Next, the operation of the video camera in the present embodiment will be explained with reference to FIG. 6. First, the operation in a frame rate curve storage mode, as one of the operation modes of the video camera, will be described. Here, the frame rate curve storage mode is a mode for storing data in the frame rate data storage section 2. When this mode is set in the video camera (see step S601), the frame rate control 13 is operated by the user, so that frame rate data indicating a variation in the frame rate over time is output to the interpolation processing section 17 (see step S602). The interpolation processing section 17 then performs interpolation of the frame rate data, and outputs the processed data to the frame rate data generating section 15 (see step S603).

The frame rate data generating section 15 shapes the input frame rate data so as to generate frame rate data suitable for recording in the frame rate data storage section 2 (see step S604). The frame rate data generating section 15 stores the generated frame rate data in the frame rate data storage section 2 (see step S605). After completion of recording of the frame rate data, the frame rate curve recording operation is stopped (see step S606).

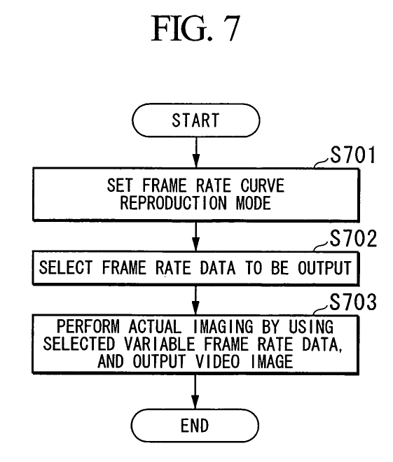

Next, the operation in a frame rate curve reproduction mode as another operation mode of the video camera will be explained with reference to FIG. 7. When the frame rate curve reproduction mode is set in the video camera (see step S701), the frame rate data to be read out and output from the frame rate data storage section 2 is selected (see step S702). The selection of the frame rate data may be performed by selecting frame rate data which is most newly generated (i.e., generated immediately before the selection), or selecting any frame rate data in accordance with designation by the user. The selected frame rate data is output from the frame rate data storage section 2 to the timing control section 3 in FIG. 1. In accordance with the above-described operation, actual imaging operation is performed, and images are shown in the display section 10, and simultaneously, image data are stored in the storage section 7 (see step S703).

As described above, the video camera of the present embodiment includes the interpolation processing section 17. Therefore, even when a discontinuous variation in the frame rate over time is input, frame rate data having a smooth variation can be obtained by interpolation (or correction) by using smoothing, approximation, or the like. Accordingly, it is possible to obtain video images in which the frame rate varies smoothly, thereby obtaining smooth motion of a moving object in the video images.

When the variation in the frame rate over time is input by manually operating the frame rate control 13, it may be difficult to perform fine control of the frame rate, and the step width of the frame rate variation may be large. Even in such a case, a smooth variation on the frame rate can be effectively obtained using the interpolation processing section 17. Generally, in order to obtain a frame rate variation as smooth as possible, control input using the frame rate control 13 should be fine so as to obtain narrow steps for designating a frame rate variation. However, such a fine control of the frame rate control 13 can be rendered unnecessary by using the interpolation processing section 17. Therefore, the quantity of manual operation of the frame rate control 13 can be reduced.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

In accordance with the present invention, based on the frame rate data which is stored in advance by the frame rate data storage section, the timing control section controls the timing of imaging of the imaging device; thus, photographing can be performed with a desired variation in the frame rate over time.

What is claimed is:

1. An imaging apparatus for performing imaging with a variable frame rate, comprising:
an imaging section for performing photoelectric conversion of an image of a subject, and outputting converted data as image data;
a frame rate data input section into which frame rate data indicating a variation in the frame rate over time is input;
a frame rate data storage section for storing the frame rate data input to the frame rate data input section; and
a timing control section for controlling timing of imaging performed by the imaging section, based on the frame rate data stored in the frame rate data storage section.

2. The imaging apparatus according to claim 1, further comprising:
a storage section having a storage medium on which the image data output from the imaging section is stored; and
a reproduction control section for controlling, in image reproduction, output of the image data from the storage medium by using the frame rate data which is used in the imaging.

3. The imaging apparatus according to claim 1, wherein:
a plurality of items of the frame rate data can be input using the frame rate data input section;
the timing control section controls the timing of imaging performed by the imaging section, based on frame rate data selected from among the plurality of items of the frame rate data stored in the frame rate data storage section; and
the imaging apparatus further comprises:
a storage section having a storage medium on which the image data output from the imaging section is stored; and
a reproduction control section for reading out frame rate data from the frame rate data storage section which is different from the frame rate data used in the imaging of the subject, and controlling, in image reproduction, output of the image data from the storage medium based on the read out frame rate data.

4. The imaging apparatus according to claim 2, further comprising:
a video encoding section for encoding the image data output from the storage medium; and
a display section for displaying images based on the image data encoded by the video encoding section,
wherein in image reproduction, the reproduction control section controls output of the image data from the storage medium based on a display frame rate of the display section.

5. The imaging apparatus according to claim 3, further comprising:
a video encoding section for encoding the image data output from the storage medium; and
a display section for displaying images based on the image data encoded by the video encoding section,
wherein in image reproduction, the reproduction control section controls output of the image data from the storage medium based on a display frame rate of the display section.

6. The imaging apparatus according to claim 4, wherein:
when the frame rate data input to the frame rate data input section is different from the display frame rate of the display section, the reproduction control section adjusts data of the image data from the storage medium so that desired image reproduction is performed at the display frame rate.

7. The imaging apparatus according to claim 5, wherein:
when the read out frame rate data is different from the display frame rate of the display section, the reproduction control section adjusts data of the image data from the storage medium so that desired image reproduction is performed at the display frame rate.

8. The imaging apparatus according to claim 1, wherein the frame rate data input section includes:
an operating device, operated by a user, for inputting a value of the frame rate;
a time data generating section for sequentially generating time data indicating an elapsed time measured from a time point; and
a frame rate data generating section for monitoring timing of input of the value of the frame rate via the operating section and the time data generated by the time data generating section, and generating the frame rate data by associating the input value of the frame rate with the time data corresponding to the timing of the input of the value of the frame rate.

9. The imaging apparatus according to claim 1, wherein the frame rate data input section includes:
a frame rate data communicating section for communicating with an external device so as to input the frame rate data from the external device.

10. The imaging apparatus according to claim 1, further comprising:
a correction processing section for performing a correction process of correcting the variation in the frame rate indicated by the frame rate data.

11. The imaging apparatus according to claim 10, wherein the correction process is an interpolation process for smoothing the variation in the frame rate.
